(19) United States
(12) Patent Application Publication
(10) Pub. No.: US 2009/0290265 A1
(43) Pub. Date: Nov. 26, 2009

(54) MAGNETIC HEAD AND MAGNETIC DISK UNIT

(75) Inventor: Junichi Kane, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/335,014

(22) Filed: Dec. 15, 2008

(30) Foreign Application Priority Data
May 26, 2008 (JP) 2008-136326

(51) Int. Cl. G11B 5/33

(52) U.S. Cl. 360/313; G9B/5.104

(57) ABSTRACT

The magnetic head having shielding layers is capable of preventing fluctuation of output caused by magnetic domain structures of the shielding layers, stabilizing the output, restraining variation of products and improving production yield. The magnetic head comprises: shielding layers for magnetically shielding a magnetoresistance effect reproducing element; hard films being located on the both sides of the magnetoresistance effect reproducing element as seen from a facing surface which faces a recording medium; and soft magnetic layers being composed of a soft magnetic material, the soft magnetic layers being located on the both sides of the shielding layers as seen from the facing surface.

### BACKGROUND OF THE INVENTION

The present invention relates to a magnetic head and a magnetic disk unit, more precisely relates to a magnetic head, in which a magnetoresistance effect reproducing element is magnetically shielded by shielding layers, and a magnetic disk unit having said magnetic head.

These days, storage capacities of storage units, e.g., magnetic disk unit, have been significantly increased. Therefore, recording density must be highly increased. With increase of plane recording density, an area for one bit of data magnetically recorded in a recording medium is reduced, and a sensor of a magnetic head, which reads data from the recording medium, is also downsized due to the reduction of said area.

FIG. 11 shows a positional relationship between a recording medium 5, from which magnetically recorded data are read, and a magnetic head 10. Generally, in the magnetic head 10, a magnetoresistance effect reproducing element 11 is provided between a lower shielding layer 12a and an upper shielding layer 12b. When the data are read, end faces of the magnetoresistance effect reproducing element 11, the lower shielding layer 12a and the upper shielding layer 12b are situated to face a surface of the recording medium 5 so as to read the data magnetically recorded in the recording medium 5.

The lower shielding layer 12a and the upper shielding layer 12b shield the magnetoresistance effect reproducing element 11 so as to prevent magnetism of bits other than an object bit from acting on the magnetoresistance effect reproducing element 11. With this structure, only the object bit, which is located immediately under the magnetoresistance effect reproducing element 11, can be sensed, so that a desired resolution can be obtained.

Conventionally, sectional shapes of the lower shielding layer 12a and the upper shielding layer 12b, each of which is defined by the head height direction and the core width direction, are rectangular shapes (see FIG. 11) or square shaped.

FIG. 12 is a sectional view of a magnetic head 10 seen from a facing surface (an air bearing surface) of a head slider, which faces a surface of a recording medium. The magnetoresistance effect reproducing element 11 of the magnetic head 10 is a spin valve type GMR (Giant Magnetoresistance) element. The spin valve type GMR element is constituted by laminating an antiferromagnetic layer 101, a pinned layer 102, a free layer 103 and a cap layer 104. The antiferromagnetic layer 101 pins a magnetization direction of the pinned layer 102 in the head height direction i.e., the direction perpendicular to the surface of the recording medium. The free layer 103 is a magnetic layer, whose magnetization direction is freely varied by magnetic signals (data) recorded in the recording medium.

A resistance value of the spin valve type GMR element is varied by the magnetization direction of the free layer 103 with respect to that of the pinned layer 102, so that the data magnetically recorded in the recording medium can be detected as resistance variation of the GMR element.

As shown in FIG. 12, the magnetoresistance effect reproducing element 11 is sandwiched between insulating layers 16 and 18, and the lower shielding layer 12a and the upper shielding layer 12b in the thickness direction (in the vertical direction in FIG. 12). To improve reproduction efficiency of the magnetoresistance effect reproducing element 11, hard films 20, which are permanent magnets, are respectively provided on the both sides of the magnetoresistance effect reproducing element 11 as seen from the facing surface. The hard films 20 direct the magnetization direction of the free layer 103 in the core width direction (in the horizontal direction in FIG. 12) when no magnetization acts on the free layer 103. The hard films 20 are composed of a magnetic material having a relatively great coercive force, e.g., Co.

In the conventional magnetic head 10, the upper shielding layer 12 has a clockwise magnetic domain structure (see FIG. 13A) or a counterclockwise magnetic domain structure (see FIG. 13B). A bias magnetic field acting on the magnetoresistance effect reproducing element 11 substantially varies according to the rotational direction of the magnetization of the upper shielding layer 12. By the variation of the bias magnetic field, the rotational angle of the free layer 103 with respect to a magnetic field of the recording medium varies and output of the magnetic head fluctuates.

To prevent the fluctuation of the output of the magnetic head, which is caused by the magnetic domain structure of the shielding layers, and stabilize the output of the magnetic head, a modified magnetic head is disclosed in Japanese Laid-open Patent Publication No. 2006-260687. The modified magnetic head 100 is shown in FIGS. 16A and 16B.

The magnetic head 100 has a magnetoresistance effect reproducing element 111 and shielding layers 112a and 112b, which magnetically shield the magnetoresistance effect reproducing element 111, and planar shapes of the shielding layers 112a and 112b are polygonal shapes and asymmetrical in the head height direction (see FIG. 16A), so that a magnetic domain structure of the shielding layers can be uniquely defined (see FIG. 16B).

### SUMMARY OF THE INVENTION

The present invention was conceived to solve the above described problems.

An object of the present invention is to provide a magnetic head having shielding layers, which is capable of preventing fluctuation of output caused by magnetic domain structures of the shielding layers, stabilizing the output, restraining variation of products and improving production yield.

Another object is to provide a magnetic disk unit including the magnetic head of the present invention.

To achieve the objects, the present invention has following structures.

Namely, the magnetic head of the present invention comprises: shielding layers for magnetically shielding a magnetoresistance effect reproducing element; hard films being located on the both sides of the magnetoresistance effect reproducing element as seen from a facing surface which faces a recording medium; and soft magnetic layers being composed of a soft magnetic material, the soft magnetic layers being located on the both sides of the shielding layers as seen from the facing surface.

With this structure, directions of magnetic domain structures of the shielding layers can be set, by magnetic domain structures of the soft magnetic layers, in a unique direction with respect to the magnetoresistance effect reproducing element.

In the magnetic head, the soft magnetic layers may be extended outward from edges of plating base layers, which are respectively formed under the shielding layers, as seen from the facing surface.

With this structure, the soft magnetic layers and the plating base layers can be simultaneously formed, so that a production process of the magnetic head can be simplified. The layers can be formed efficiently.

In the magnetic head, antiferromagnetic layers, which are composed of an antiferromagnetic material, may be respectively formed on the soft magnetic layers.

With this structure, magnetic domain structures of the soft magnetic layers can be securely set in a unique direction by exchange coupling function of the antiferromagnetic layers.

Preferably, a sectional shape of each of the soft magnetic layers, which is defined by the head height direction and the core width direction, is a rectangular shape or a triangular shape.

The magnetic disk unit of the present invention comprises: a head slider including a magnetic head, which has shielding layers for magnetically shielding a magnetoresistance effect reproducing element, hard films being located on the both sides of the magnetoresistance effect reproducing element as seen from a facing surface which faces a recording medium, and soft magnetic layers being composed of a soft magnetic material, the soft magnetic layers being located on the both sides of the hard films as seen from the facing surface; a suspension supporting the head slider; a rotatable actuator arm having an end, to which an end of the suspension is fixed; and an electric signal detection circuit being electrically connected to the magnetoresistance effect reproducing element, via insulated cables provided on the suspension and the actuator arm, so as to read data recorded in the recording medium.

With this structure, output of the magnetic head is not fluctuated, so that output of the magnetic disk unit can be stabilized.

In the magnetic head of the present invention, the magnetic domain structures of the shielding layers, which are formed by a magnetizing treatment performed in the production process of the magnetic head (reproducing head), can be set in a unique direction. Therefore, a fixed bias magnetic field acting on the magnetoresistance effect reproducing element of the magnetic head can be maintained, so that the output of the magnetic head can be stabilized without fluctuation. By restraining the fluctuation, production yield can be improved.

In the magnetic disk unit of the present invention, the magnetic head, whose output is stabilized, is used as the reproducing head, so that a highly reliable magnetic disk unit can be produced.

### BRIEF DESCRIPTION OF THE DRAWINGS

Embodiments of the present invention will now be described by way of examples and with reference to the accompanying drawings, in which:

FIG. 1 is a schematic perspective view of a magnetic head of a first embodiment of the present invention;

FIG. 2 is an explanation view showing a magnetic domain structure of a shielding layer of the magnetic head;

FIG. 3 is a schematic perspective view of a magnetic head of a second embodiment;

FIG. 4 is an explanation view showing a magnetic domain structure of a shielding layer of the magnetic head shown in FIG. 3;

FIG. 5 is a sectional view of the magnetic head shown in FIG. 1;

FIG. 6 is a sectional view of a magnetic head of a third embodiment;

FIGS. 7-10 are explanation views showing a production process of antiferromagnetic layers of the third embodiment;

FIG. 11 is a schematic perspective view showing the lower shielding layer and the upper shielding layer of the conventional magnetic head;

FIG. 12 is a sectional view of the conventional magnetic head;

FIGS. 13A and 13B are explanation views showing the magnetic domain structures of the shielding layer of the conventional magnetic head;

FIGS. 14A and 14B are explanation views showing function of the shielding layers to the magnetoresistance effect reproducing element of the conventional magnetic head;

FIG. 15 is a plan view of a magnetic disk unit having the magnetic head of the present invention; and

FIG. 16A is a schematic perspective view of another conventional magnetic head; and

FIG. 16B is an explanation view showing the magnetic domain structure of the shielding layer.

### DETAILED DESCRIPTION OF THE EMBODIMENTS

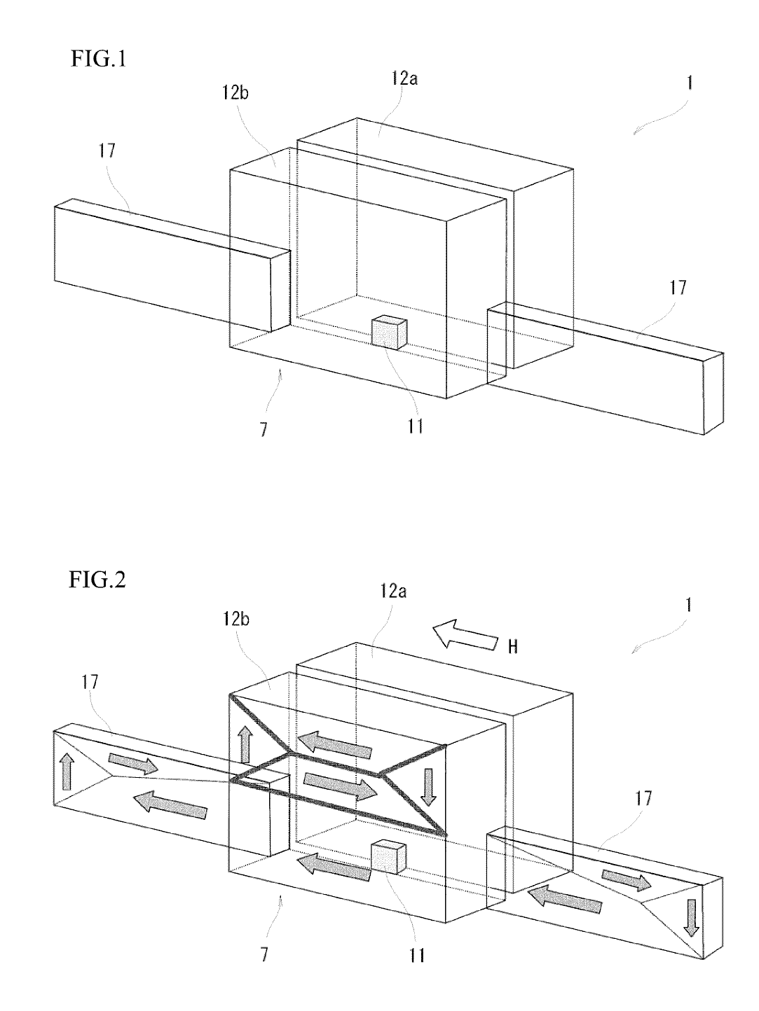

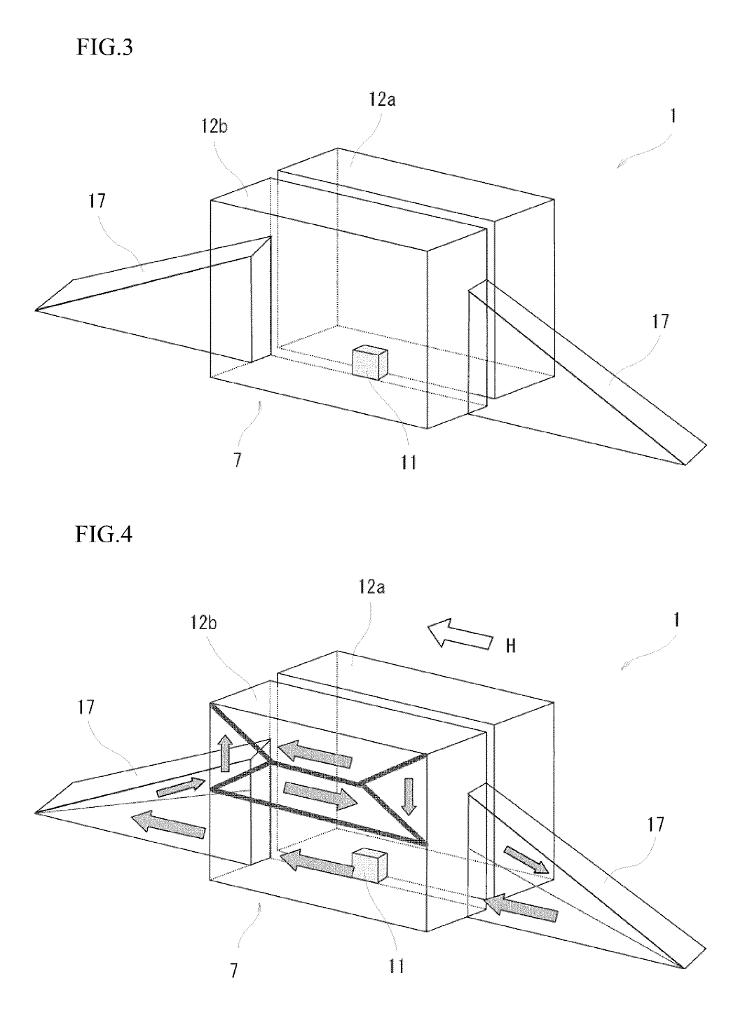

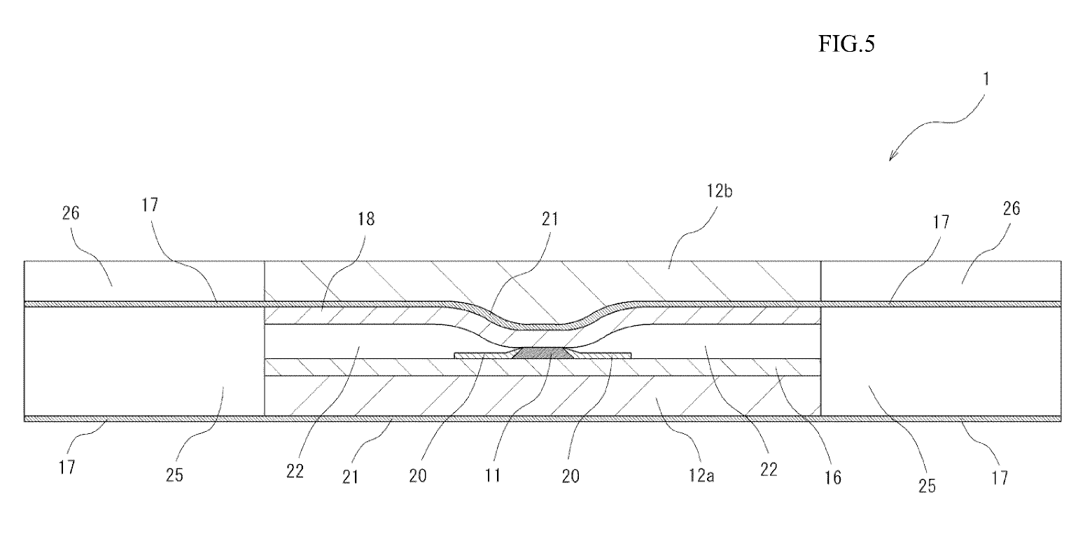

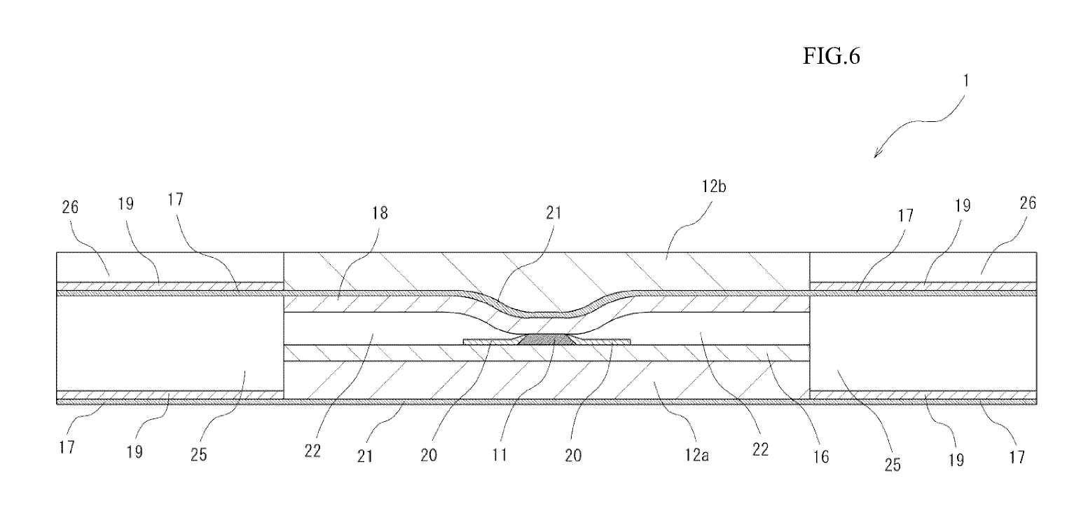

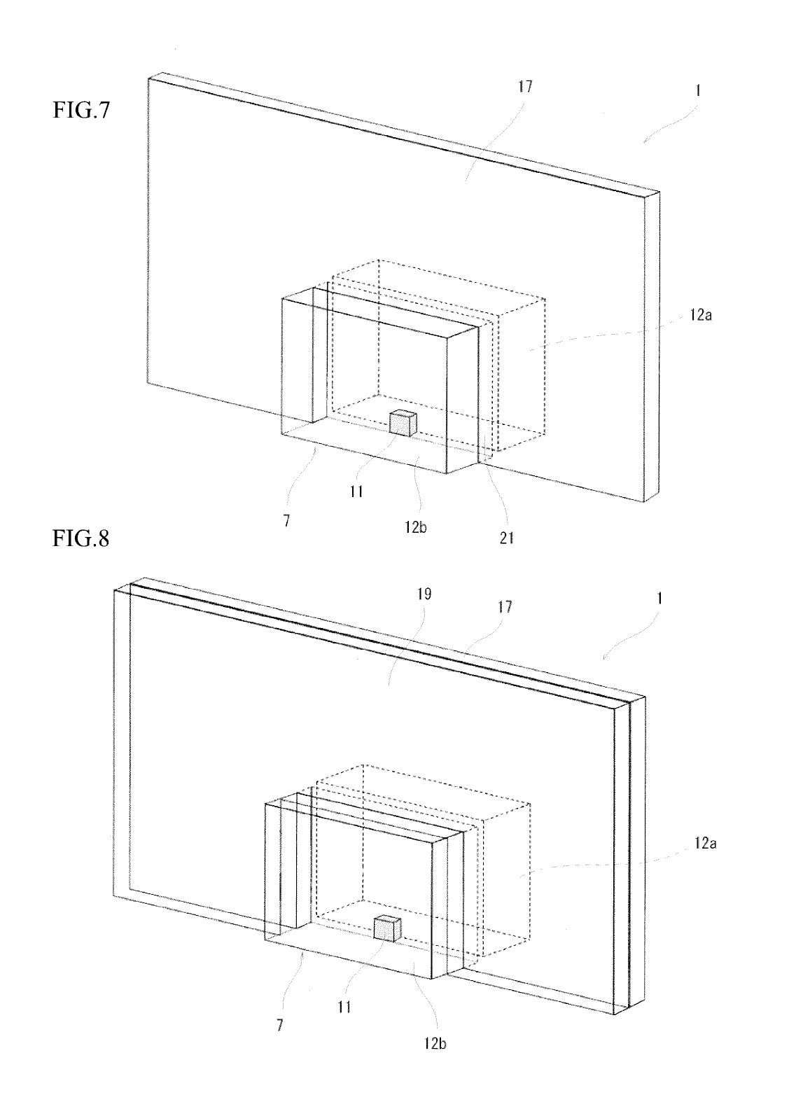

Preferred embodiments of the present invention will now be described in detail with reference to the accompanying drawings, in which: FIG. 1 is a schematic perspective view of a magnetic head 1 of a first embodiment of the present invention; FIG. 2 is an explanation view showing a magnetic domain structure of a shielding layer 12 of the magnetic head 1; FIG. 3 is a schematic perspective view of a magnetic head 1 of a second embodiment; FIG. 4 is an explanation view showing a magnetic domain structure of a shielding layer 12 of the magnetic head 1 shown in FIG. 3; FIG. 5 is a sectional view of the magnetic head 1 shown in FIG. 1; FIG. 6 is a sectional view of a magnetic head 1 of a third embodiment; and FIGS. 7-10 are explanation views showing a production process of antiferromagnetic layers of the third embodiment.

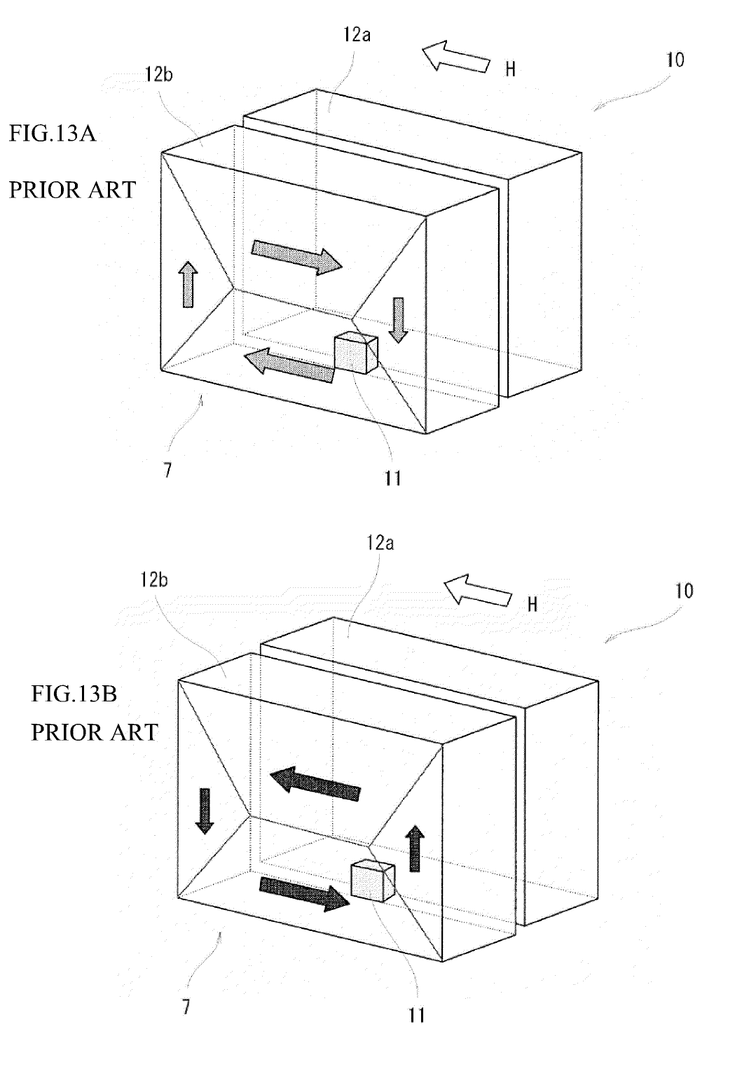

Generally, the process of producing the conventional magnetic head 10 (see FIG. 12), which has the hard films 20 for controlling magnetic domains of the free layer 103 of the magnetoresistance effect reproducing element 11, includes a step of magnetizing the hard films 20 and directing magnetization directions thereof in the core width direction by applying a magnetic field H (see FIGS. 13A and 13B) of about 5 [kOe]. In this step, the magnetization directions of magnetic layers constituting the magnetic head 10 are once directed in the magnetizing direction, but the magnetization directions vary after the magnetic field H is disappeared. Namely, the magnetization directions of the hard films 20 nearly correspond to the magnetizing direction; the magnetization direction of the free layer 103 is nearly corresponded to the magnetizing direction by bias magnetic fields of the hard films 20; and the magnetization direction of the pinned layer 102 is directed in the head height direction, without reference to the magnetizing direction, by the function of the antiferromagnetic layer 101.

Since the lower shielding layer 12a and the upper shielding layer 12b are composed of a soft magnetic material having very small coercive forces, their magnetized patterns after disappearing the magnetic field H have structures for minimizing static magnetic energy. Namely, the entire shielding layer including the lower and the upper shielding layers 12a and 12b has a magnetic domain structure in which macroscopic magnetization is nearly zero. After disappearing the magnetic field H, the lower and the upper shielding layers 12a and 12b have reflux magnetic domain structures as shown in FIG. 13A or 13B. FIG. 13A shows the clockwise magnetic domain structure; FIG. 13B shows the counterclockwise magnetic domain structure.

While magnetizing the lower and the upper shielding layers 12a and 12b, the magnetization directions correspond to the magnetizing direction. However, their magnetic domain structures, i.e., the clockwise magnetic domain structure or the counterclockwise magnetic domain structure, formed after disappearing the magnetic field H cannot be controlled. The lower and the upper shielding layers 12a and 12b have bilaterally-symmetric configurations, so appearance ratio of the clockwise magnetic domain structure and the counterclockwise magnetic domain structure is 1:1. Namely, the clockwise magnetic domain structure and the counterclockwise magnetic domain structure evenly formed.

In the lower and the upper shielding layers 12a and 12b, core widths are from several dozen μm to 100 μm, and heights in the head height direction are several dozen μm. On the other hand, in the magnetoresistance effect reproducing element 11, a core width and a height in the head height direction are about 100 nm. Namely, the magnetoresistance effect reproducing element 11 is much smaller than the shielding layers 12a and 12b (one-several hundredth to one-thousandth).

Therefore, in case of the clockwise magnetic domain structure shown in FIG. 13A, the magnetic domain structures of the shielding layers 12a and 12b with respect to the magnetoresistance effect reproducing element 11 are equivalent to that evenly magnetized in the left direction. On the other hand, in case of the counterclockwise magnetic domain structure shown in FIG. 13B, the magnetic domain structures of the shielding layers 12a and 12b with respect to the magnetoresistance effect reproducing element 11 are equivalent to that evenly magnetized in the right direction.

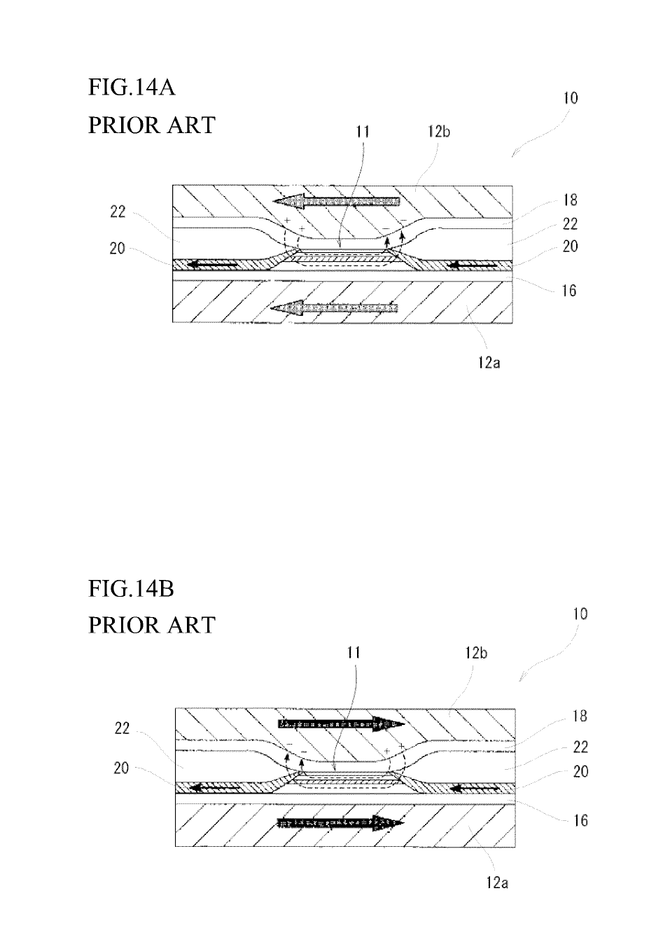

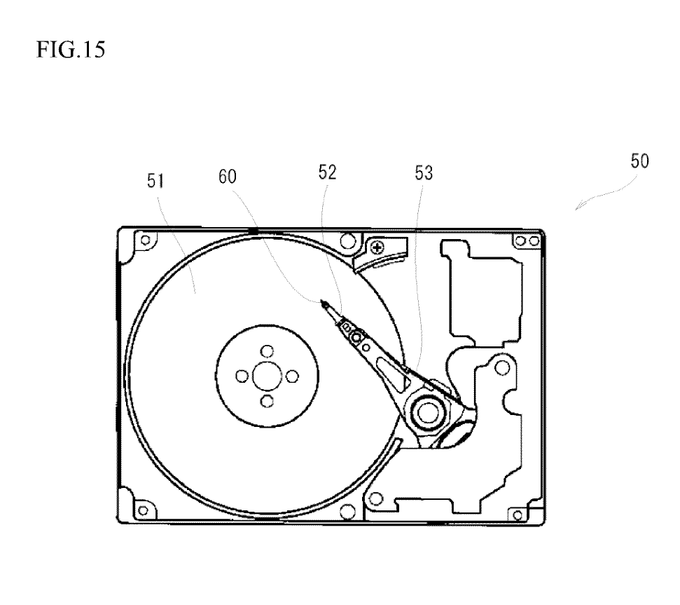

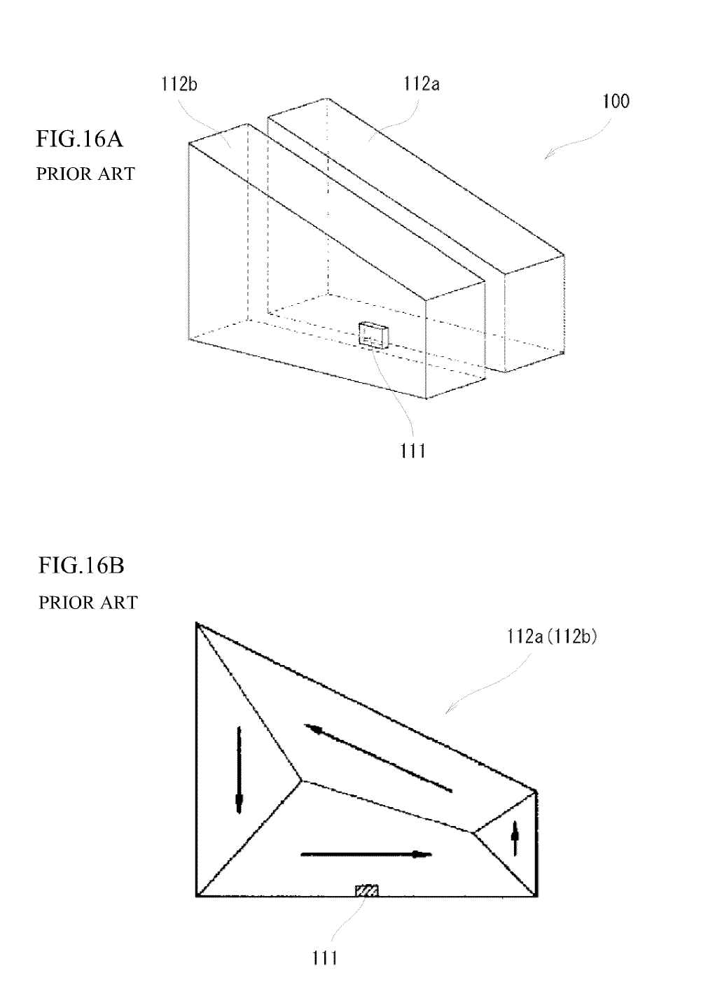

In case of using a CIP-GMR (Current In Plane-GMR) element as the magnetoresistance effect reproducing element 11, as shown in FIGS. 14A and 14B, electrodes 22 are respectively provided on the both sides of the magnetoresistance effect reproducing element 11, so a part of the upper shielding layer 12b, which corresponds to the magnetoresistance effect reproducing element 11, is projected downward or projected toward the magnetoresistance effect reproducing element 11. As described above, the lower shielding layer 12a is magnetized in the left direction or the right direction, so a boundary surface of the projected part of the upper shielding layer 12b is magnetically charged and a magnetic field shown by dotted lines acts on the magnetoresistance effect reproducing element 11. Note that, in the above described example, the projected part is formed in the upper shielding layer 12b of the CIP-GMR element, but the similar problem will occur if the projected part of the lower and/or the upper shielding layer is formed near a CIP-GMR element, a CPP-GMR element or a TMR element.

In FIG. 14A, the upper shielding layer 12b is magnetized in the left direction equivalently. In this case, the magnetic field generated by the projected part of the upper shielding layer 12b is directed in the opposite direction to the direction of the bias magnetic fields of the hard films 20, which act in the core width direction, thereby the bias magnetic fields are reduced.

On the other hand, in FIG. 14B, the upper shielding layer 12b is magnetized in the right direction equivalently. In this case, the magnetic field generated by the projected part of the upper shielding layer 12b is directed in the direction of the bias magnetic fields of the hard films 20, thereby the bias magnetic fields are increased.

As described above, in the conventional magnetic head 10, the bias magnetic fields acting on the magnetoresistance effect reproducing element 11 are substantially fluctuated on the basis of the reflux direction of the magnetic domain structure of the upper shielding layer 12b. By the fluctuation of the bias magnetic fields, the rotational angle of the free layer 103 with respect to a magnetic field of a recording medium is varied and output of the magnetic head 10 is fluctuated.

Thus, the magnetic heads of the following embodiments are capable of uniquely define magnetic domain structures of shielding layers so as to stabilize output of the magnetic heads.

### First Embodiment

The magnetic head of a first embodiment of the present invention will be explained. Note that, a basic structure of the magnetic head is the same as that of the conventional magnetic head 10, so the structural members described above are assigned the same symbols and explanation will be omitted.

FIG. 1 is a schematic perspective view of the magnetic head 1, which has the lower shielding layer 12a and the upper shielding layer 12b having unique shapes.

Note that, a GMR element, a TMR element, etc. may be used as the magnetoresistance effect reproducing element 11, and a film structure of the element is not limited.

The present embodiment is characterized by soft magnetic layers 17 which are respectively provided on the both sides of the lower and the upper shielding layers 12a and 12b as seen from a facing surface (an air bearing surface) 7, which will face a surface of a recording medium. Note that, in FIG. 1, the soft magnetic layers 17 are shown on the both sides of only the upper shielding layer 12b for ease of explanation. The soft magnetic layers 17 are composed of a soft magnetic material, e.g., NiFe.

As shown in FIG. 1, the soft magnetic layers 17 are situated nearer the facing surface 7 or the magnetoresistance effect reproducing element 11, in the head height direction.

An example of the soft magnetic layers 17 is shown in FIG. 5. Plating base layers 21 are respectively formed under the shielding layers 12a and 12b. The plating base layers 21 are outwardly extended from edges of the shielding layers 12a and 12b as seen from the facing surface 7. The extended parts of the plating base layers 21 are the soft magnetic layers 17. Namely, widths of the plating base layers 21 in the core width direction are wider than those of the shielding layers 12a and 12b so as to form the soft magnetic layers 17.

In the present embodiment, the soft magnetic layers 17 and the plating base layers 21 are simultaneously formed, so they are continuously formed and have the same thickness. Note that, the soft magnetic layers 17 and the plating base layers 21 need not be formed simultaneously and may have different shapes and thicknesses.

The soft magnetic layers 17 and the plating base layers 21 are composed of the same material or material having the same function, so the base plating layers 21 are considered as parts of the shielding layers 12a and 12b. Therefore, the extended parts of the plating base layers 21, i.e., the soft magnetic layers 17, are outwardly extended from the side edges of the shielding layers 12a and 12b as seen from the facing surface 7 side, and thereby the soft magnetic layers 17 can be located on the both sides of the shielding layers 12a and 12b in the core width direction.

Further, the soft magnetic layers 17 may be located near the shielding layers 12a and 12b. For example, the soft magnetic layers 17 may be located on the both sides of a layer above or under the shielding layer 12a or 12b. In this case too, the same effects can be obtained.

In the present embodiment, as shown in FIG. 1, a sectional shape of each of the soft magnetic layers 17, which is defined by the head height direction and the core width direction, is a rectangular shape. Note that, the left soft magnetic layer 17 and the right soft magnetic layer 17 may have different sectional shapes.

FIG. 2 is an explanation view showing a magnetic domain structure of the shielding layers 12a and 12b of the magnetic head 1, wherein a magnetic field for magnetizing the shielding layers 12a and 12b has been disappeared. In FIG. 2 too, the magnetic domain structure of only the shielding layer 12b is shown for ease of explanation. A symbol H stands for the magnetic field for magnetizing the shielding layers 12a and 12b, whose direction is indicated by an arrow. Since the shielding layers 12a and 12b are composed of the soft magnetic material, e.g., NiFe, the shielding layers 12a and 12b are magnetized in the direction of the magnetic field H while the magnetic field H is applied. Upon disappearing the magnetic field H, a reflux magnetic domain structure, in which residual magnetization is microscopically nearly zero, is formed.

The present embodiment is characterized by the soft magnetic layers 17 located on the both sides of the shielding layers 12a and 12b as seen from the facing surface 7 side. With this structure, the direction of the magnetic domains of the shielding layers 12a and 12b corresponding to the magnetoresistance effect reproducing element 11 can be uniquely set.

More precisely, the magnetic domain structures shown in FIG. 2 are formed in the soft magnetic layers 17, which are composed of the soft magnetic material and which are located on the both sides of the shielding layers 12a and 12b as seen from the facing surface 7 side, when the magnetic field H is disappeared. The magnetic domain structures of the soft magnetic layers 17 direct the magnetic domains of the shielding layers 12a and 12b as shown in FIG. 2.

Namely, in each of the shielding layers 12a and 12b, a magnetic domain directed leftward appears in a part located between the soft magnetic layers 17 and close to the facing surface 7, i.e., a part corresponding to the magnetoresistance effect reproducing element 11; a reflux magnetic domain structure appears in another part which is not located between the soft magnetic layers 17, as shown in FIG. 2.

In each of the shielding layers 12a and 12b, the magnetic domain structure can be controlled in the unique direction with respect to the magnetoresistance effect reproducing element 11. In the present embodiment, as shown in FIG. 2, the magnetic domain structures of the shielding layers 12a and 12b are controlled leftward as seen from the facing surface 7 side.

As described above, if the magnetic domain structures of the shielding layers 12a and 12b cannot be uniquely set, magnetic fields directed in the different directions will act on the magnetoresistance effect reproducing element 11 and output of the magnetic head 1 will be fluctuated.

However, in the present embodiment, the magnetic domain structures of the shielding layers 12a and 12b can be uniquely set as shown in FIG. 2, so that the bias magnetic fields acting on the magnetoresistance effect reproducing element 11 are not varied by the magnetic domain structures of the shielding layers 12a and 12b. Therefore, the problem of the output fluctuation of the magnetic head 1 can be solved.

Unlike the conventional method of controlling magnetic domain structures, the magnetic domain structures are controlled on the basis of shape anisotropy of the plating base layers 21, so that the magnetic domains of the shielding layers 12a and 12b can be securely controlled.

### Second Embodiment

Next, a second embodiment will be explained. Note that, a basic structure of the magnetic head of the second embodiment is the same as that of the first embodiment, so the structural members described above are assigned the same symbols and explanation will be omitted.

As shown in FIG. 3, the magnetic head 1 of the second embodiment is characterized in that a sectional shape of each of the soft magnetic layers 17, which is defined by the head height direction and the core width direction, is a triangular shape. In FIG. 3 too, the soft magnetic layers 17 are shown on the both sides of only the upper shielding layer 12b for ease of explanation. The left soft magnetic layer 17 and the right soft magnetic layer 17 may have different sectional shapes as well as the first embodiment.

FIG. 4 shows a magnetic domain structure of the shielding layers 12a and 12b of the magnetic head 1, wherein the magnetic field H for magnetizing the shielding layers 12a and 12b has been disappeared. The soft magnetic layers 17 are shown on the both sides of only the upper shielding layer 12b for ease of explanation as well as FIG. 3. Note that, the direction of the magnetic field H is indicated by an arrow.

More precisely, the magnetic domain structures shown in FIG. 4 are formed in the soft magnetic layers 17, which are composed of the soft magnetic material and which are located on the both sides of the shielding layers 12a and 12b as seen from the facing surface 7 side, when the magnetic field H is disappeared. The magnetic domain structures of the soft magnetic layers 17 direct the magnetic domains of the shielding layers 12a and 12b as shown in FIG. 4.

Namely, in each of the shielding layers 12a and 12b, a magnetic domain directed leftward appears in a part located between the soft magnetic layers 17 and close to the facing surface 7, i.e., a part corresponding to the magnetoresistance effect reproducing element 11; a reflux magnetic domain structure appears in another part which is not located between the soft magnetic layers 17, as shown in FIG. 4.

In each of the shielding layers 12a and 12b, the magnetic domain structures can be controlled in the unique direction with respect to the magnetoresistance effect reproducing element 11. In the present embodiment, as shown in FIG. 4, the magnetic domain structures of the shielding layers 12a and 12b are controlled leftward as seen from the facing surface 7 side. Namely, the effects which are the same as those of the first embodiment can be obtained.

### Third Embodiment

Next, a third embodiment will be explained. Note that, a basic structure of the magnetic head of the third embodiment is the same as those of the foregoing embodiments, so the structural members described above are assigned the same symbols and explanation will be omitted.

As shown in FIG. 6, the magnetic head 1 of the third embodiment is characterized in that antiferromagnetic layers 19, which are composed of an antiferromagnetic material, e.g., IrMn, are respectively laminated on the soft magnetic layers 17 shown in FIG. 1 or 3.

The antiferromagnetic layers 19 pin the magnetization directions of the soft magnetic layers by exchange coupling function, so that the magnetic domain structures of the soft magnetic layers 17 can be securely directed in the unique direction as shown in FIG. 2 or 4.

Shapes of the antiferromagnetic layers 19 are defined, on the basis of the shapes of the soft magnetic layers 17, so as to optimally produce the exchange coupling function.

Next, a production process of the antiferromagnetic layers 19 will be explained with reference to FIGS. 7-10. Note that, for ease of explanation, the process of producing the antiferromagnetic layers 19 on the upper shielding layer 12b side will be explained. The antiferromagnetic layers 19 on the lower shielding layer 12a side are produced by the same process.

Firstly, as shown in FIG. 7, the soft magnetic layer 17 enclosing the shielding layer 12b is formed. The soft magnetic layer 17 is formed by extending the plating base layer 21, which is formed under the shielding layer 12b, beyond side edges of the shielding layer 12b as well as the first embodiment.

Next, as shown in FIG. 8, the antiferromagnetic layer 19 is formed on the entire surface of the soft magnetic layer 17, which has been formed to enclose the shielding layer 12b. Note that, the antiferromagnetic layer 19 may be simultaneously formed on the shielding layer 12b.

Next, as shown in FIG. 9, resist layers 30, whose shapes correspond to those of the completed soft magnetic layers 17, are formed on the antiferromagnetic layer 19.

Then, one side surface of the antiferromagnetic layer 19, on which the resist layers 30 are formed, is dry-etched by, for example, an ion mill process, so as to remove a part of the antiferromagnetic layer 19 and a part of the soft magnetic layer 17, which are not covered with the resist layers 30.

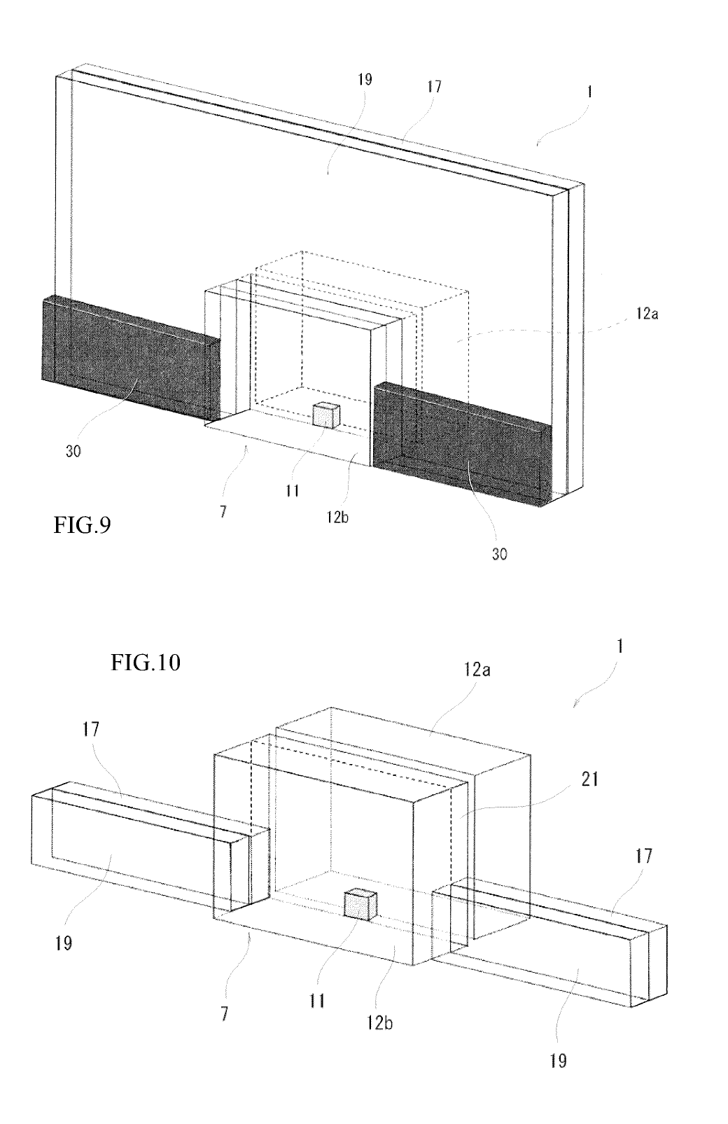

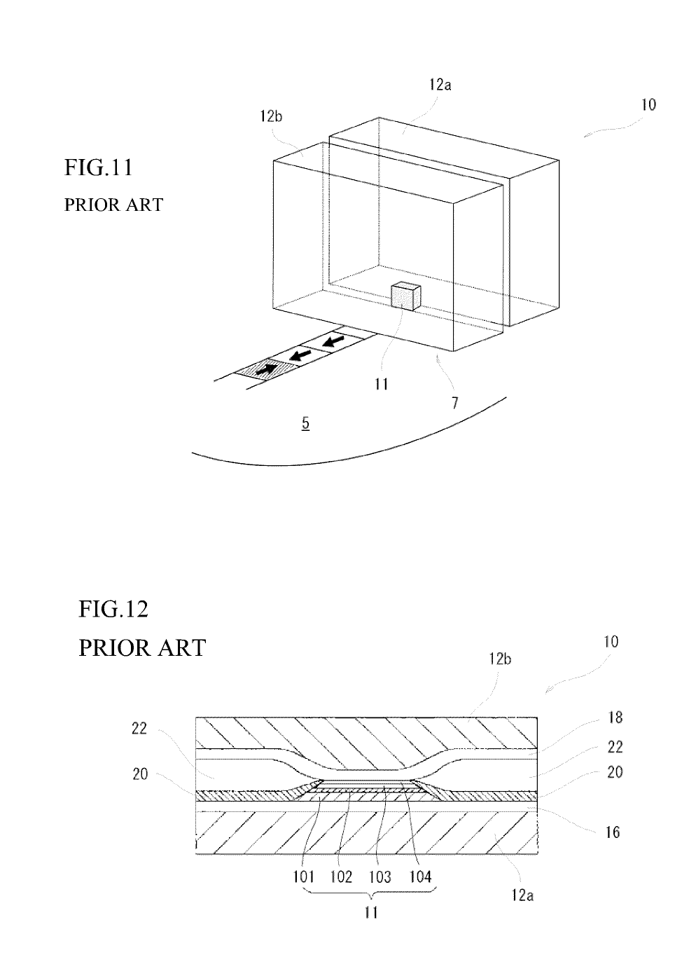

After completing the ion mill process, the resist layers 30 are removed as shown in FIG. 10, so that the antiferromagnetic layers 19 are formed on the soft magnetic layers 17 which are located on the both sides of the shielding layer 12b. In this case, the magnetic domain structures are formed as shown in FIG. 2.

Note that, in the present embodiment, the soft magnetic layers 17 and the antiferromagnetic layers 19 are formed into rectangular shapes, but their shapes are not limited to the present embodiment.

In the magnetic head of the present embodiment too, the magnetic domain structures formed in the shielding layers 12a and 12b can be directed in the unique direction. Therefore, the output fluctuation of the magnetic head can be prevented, and the output can be stabilized.

The present invention relates to the magnetic head having the magnetoresistance effect reproducing element 11 is characterized in that the lower shielding layer 12a and the upper shielding layer 12b are respectively located on the both sides of the magnetoresistance effect reproducing element 11 in the thickness direction as seen from the facing surface, that the soft magnetic layers 17 are respectively located on the both sides of each of the shielding layers 12a and 12b in the core width direction as seen from the facing surface and that the magnetic domain structures of the shielding layers 12a and 12b are controlled, by the magnetic domain structures of the soft magnetic layers 17, to form the unique magnetic domain structures.

Therefore, the present invention can be applied to not only the magnetic head including the shielding layers and the spin valve type GMR element but also other magnetic heads including shielding layers and a magnetoresistance effect reproducing element, e.g., MR (Magnetoresistance) element, TMR (Tunneling Magnetoresistance) element, CPP-GMR (Current Perpendicular to Plane-GMR) element. In any cases, the magnetic domain structures of the shielding layers can be uniquely set, so that the output fluctuation of the magnetic head can be prevented.

By employing the magnetic head of the present invention, a magnetic disk unit capable of corresponding to high recording density and realizing high reproduction sensitivity and a magnetoresistance device, e.g., MRAM, having superior storage characteristics can be produced.

An embodiment of a magnetic disk unit 50 is shown in FIG. 15. The magnetic head 1 is attached to a head slider 60, which magnetically records data in a recording medium (magnetic disk) 51 and reads data from the medium 51. The head slider 60 is attached to a facing surface of a head suspension 52, which faces the magnetic disk 51. An end of the head suspension 52 is fixed to a rotatable actuator arm 53. An electric signal detection circuit is electrically connected to the magnetoresistance effect reproducing element 11, via insulated cables provided on the suspension 52 and the actuator arm 53, so as to read data recorded in the magnetic disk 51. By rotating the magnetic disk 51, the head slider 60 is floated from a surface of the magnetic disk 51, so that data can be read from the magnetic disk 51 and recorded therein.

In the magnetic disk unit of the present embodiment, output of the magnetic head is stabilized, so that the magnetic disk unit, which is capable of corresponding to high recording density and stably outputting, can be produced.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A magnetic head,
comprising:
shielding layers for magnetically shielding a magnetoresistance effect reproducing element;
hard films being located on the both sides of the magnetoresistance effect reproducing element as seen from a facing surface which faces a recording medium; and
soft magnetic layers being composed of a soft magnetic material, said soft magnetic layers being located on the both sides of said shielding layers as seen from the facing surface.

2. The magnetic head according to claim 1,
wherein said soft magnetic layers are extended outward from edges of plating base layers, which are respectively formed under said shielding layers, as seen from the facing surface.

3. The magnetic head according to claim 1
wherein antiferromagnetic layers, which are composed of an antiferromagnetic material, are respectively formed on said soft magnetic layers.

4. The magnetic head according to claim 2
wherein antiferromagnetic layers, which are composed of an antiferromagnetic material, are respectively formed on said soft magnetic layers.

5. The magnetic head according to claim 1,
wherein said soft magnetic layers are situated nearer the facing surface in the head height direction.

6. The magnetic head according to claim 2,
wherein said soft magnetic layers are situated nearer the facing surface in the head height direction.

7. The magnetic head according to claim 3,
wherein said soft magnetic layers are situated nearer the facing surface in the head height direction.

8. The magnetic head according to claim 4,
wherein said soft magnetic layers are situated nearer the facing surface in the head height direction.

9. The magnetic head according to claim 1,
wherein a sectional shape of each of said soft magnetic layers, which is defined by the head height direction and the core width direction, is a rectangular shape or a triangular shape.

10. The magnetic head according to claim 2,
wherein a sectional shape of each of said soft magnetic layers, which is defined by the head height direction and the core width direction, is a rectangular shape or a triangular shape.

11. The magnetic head according to claim 3,
wherein a sectional shape of each of said soft magnetic layers, which is defined by the head height direction and the core width direction, is a rectangular shape or a triangular shape.

12. The magnetic head according to claim 4,
wherein a sectional shape of each of said soft magnetic layers, which is defined by the head height direction and the core width direction, is a rectangular shape or a triangular shape.

13. The magnetic head according to claim 5,
wherein a sectional shape of each of said soft magnetic layers, which is defined by the head height direction and the core width direction, is a rectangular shape or a triangular shape.

14. The magnetic head according to claim 6,
wherein a sectional shape of each of said soft magnetic layers, which is defined by the head height direction and the core width direction, is a rectangular shape or a triangular shape.

15. The magnetic head according to claim 7,
wherein a sectional shape of each of said soft magnetic layers, which is defined by the head height direction and the core width direction, is a rectangular shape or a triangular shape.

16. The magnetic head according to claim 8,
wherein a sectional shape of each of said soft magnetic layers, which is defined by the head height direction and the core width direction, is a rectangular shape or a triangular shape.

17. A magnetic disk unit,
comprising:
a head slider including a magnetic head, which has shielding layers for magnetically shielding a magnetoresistance effect reproducing element, hard films being located on the both sides of the magnetoresistance effect reproducing element as seen from a facing surface which faces a recording medium, and soft magnetic layers being composed of a soft magnetic material, the soft magnetic layers being located on the both sides of the hard films as seen from the facing surface;
a suspension supporting said head slider;
a rotatable actuator arm having an end, to which an end of said suspension is fixed; and
an electric signal detection circuit being electrically connected to the magnetoresistance effect reproducing element, via insulated cables provided on said suspension and said actuator arm, so as to read data recorded in the recording medium.
